(19) United States
(12) Patent Application Publication
(10) Pub. No.: US 2013/0314018 A1
(43) Pub. Date: Nov. 28, 2013

(54) APPARATUS AND METHOD FOR CONTROLLING MOTOR SPEED

(71) Applicant: SAMSUNG ELECTRO-MECHANICS CO., LTD., Gyeonggi-do (KR)

(72) Inventor: Bon Young Gu, Gyeonggi-do (KR)

(73) Assignee: SAMSUNG ELECTRO-MECHANICS CO., LTD., Gyeonggi-do (KR)

(21) Appl. No.: 13/900,467

(22) Filed: May 22, 2013

(30) Foreign Application Priority Data
May 24, 2012 (KR) 10-2012-0055485

(51) Int. Cl. H02P 29/00

(52) U.S. Cl. CPC H02P 29/0005
USPC 318/461

(57) ABSTRACT

The present invention relates to an apparatus and a method for controlling a motor speed. In accordance with an embodiment of the present invention, an apparatus for controlling a motor speed including: a speed difference detecting unit for calculating a difference between a motor control speed and a detected motor speed; a duty generating unit for changing a duty according to the speed difference detected by the speed difference detecting unit and duty update time adjustment; and a time adjusting unit for adjusting a duty update time according to a duty variation in the duty generating unit is provided. Further, a method for controlling a motor speed is provided.

### CROSS-REFERENCE TO RELATED APPLICATIONS

Claim and incorporate by reference domestic priority application and foreign priority application as follows:

“CROSS REFERENCE TO RELATED APPLICATION

This application claims the benefit under 35 U.S.C. Section 119 of Korean Patent Application Serial No. 10-2012-0055485, entitled filed May 24, 2012, which is hereby incorporated by reference in its entirety into this application.”

### BACKGROUND OF THE INVENTION

1. Field of the Invention

The present invention relates to an apparatus and a method for controlling a motor speed, and more particularly, to an apparatus and a method for controlling a motor speed that can stably change the speed of a motor by adjusting a duty update time interval.

2. Description of the Related Art

Generally, in order to control the speed of a motor, the current speed of the motor is detected, and a PWM duty is adjusted according to the difference between the detected speed and a target speed.

At this time, the speed of the motor is detected using a Hall signal, and a reference speed, that is, a motor control speed is calculated using an input PWM signal. The duty, an input into a PWM generator, is adjusted according to the difference between the speed of the motor and the reference speed so that the speed of the motor becomes the reference speed.

When the speed of the motor is slowly changed according to the change of the PWM duty, the speed control duty of the motor may be unstable and oscillate since the duty is updated during the speed change of the motor. In this case, it is possible to stably change the speed of the motor by adjusting a duty variation according to the difference between the reference speed and the speed of the motor using a gain value. At this time, from the linear relation that an RPM is increased according to the increase in duty, an RPM value corresponding to a duty is calculated as a reference speed (target control speed).

However, at this time, when the duty value is increased in order to increase the RPM (speed of motor) to a desired value, the speed of the motor is increased, and when the duty is compared with the RPM while the speed of the motor increases, the duty is further increased to greater than a target value. Accordingly, the speed of the motor becomes unstable. In this case, a block for controlling a gain becomes complicated when reflecting the reaction speed of the motor by adjusting the gain value.

That is, a conventional method of multiplying a difference between a reference speed and the speed of a motor by a gain when controlling the speed of the motor needs a variable with a sufficient width for accurate control. In addition, since a multiplier is needed, cost of implementation inevitably increases.

### RELATED ART DOCUMENT

### Patent Document

Patent Document 1: Japanese Patent Laid-open Publication No. Heisei 6-121576 (laid-open on Apr. 28, 1994)

Patent Document 2: Japanese Patent Laid-open Publication No. 2009-183094 (laid-open on Aug. 13, 2009)

### SUMMARY OF THE INVENTION

According to the above-described problems, it is needed to stably change the speed of a motor by simply reflecting the reaction speed of the motor.

The present invention has been invented in order to overcome the above-described problems and it is, therefore, an object of the present invention to provide an apparatus and a method for controlling a motor speed that can stably change the speed of a motor by adjusting a duty update time interval.

In accordance with a first embodiment of the present invention to achieve the object, there is provided an apparatus for controlling a motor speed including: a speed difference detecting unit for calculating a difference between a motor control speed and a detected motor speed; a duty generating unit for changing a duty according to the speed difference detected by the speed difference detecting unit and duty update time adjustment; and a time adjusting unit for adjusting a duty update time according to a duty variation in the duty generating unit.

At this time, in an example, the apparatus for controlling a motor speed may further include a gain adjustment block which receives the speed difference calculated by the speed difference detecting unit to output a gain adjustment value according to the speed difference to the duty generating unit, and the duty generating unit may change the duty according to the gain adjustment value output from the gain adjustment block and the duty update time adjustment.

Further, in an example, the duty generating unit may include an adder which adds the adjustment value according to the speed difference calculated by the speed difference detecting unit and a duty value generated by a duty generator in the previous step to output the added value; a selector which multi-receives an output of the adder and the duty value generated by the duty generator in the previous step to output any one according to the control of the time adjusting unit; and the duty generator which generates the duty by changing the duty when an output of the selector is a signal selected from the output of the adder while receiving the output of the selector to generate the duty.

At this time, in another example, the time adjusting unit may control the selector to select and output the duty value generated in the previous step, which is received by the selector, when the duty variation is greater than a preset value.

Moreover, in another example, the time adjusting unit may control the selector to continuously select and output the duty value generated in the previous step, which is received by the selector, for a set time corresponding to the size of the duty variation.

Further, in an example, the apparatus for controlling a motor speed may further include a duty-RPM converting unit which calculates the motor control speed from a PWM control signal to output the motor control speed to the speed difference detecting unit.

At this time, in accordance with another example, the duty-RPM converting unit may include a duty detector for detecting a duty from the PWM control signal; and an RPM converter for converting the duty signal detected by the duty detector into an RPM signal.

In accordance with another example, the apparatus for controlling a motor speed may further include a motor speed detector which detects the motor speed from a Hall sensor signal of the motor to output the motor speed to the speed difference detecting unit.

Further, in an example, the apparatus for controlling a motor speed may further include a PWM generator for generating the PWM control signal for controlling the rotational speed of the motor from the duty value output from the duty generating unit.

Next, in accordance with a second embodiment of the present invention to achieve the object, there is provided a method for controlling a motor speed including: a speed difference detection step of calculating a difference between a motor control speed and a detected motor speed; a duty generation step of generating a duty by changing the duty according to the speed difference detected in the speed difference detection step and duty update time adjustment; and a feedback time adjustment step of feeding back a duty variation generated in the duty generation step to adjust a duty update time for control in the duty generation step.

At this time, in an example, the method for controlling a motor speed may further include a gain adjustment step of receiving the speed difference calculated in the speed difference detection step, outputting a gain adjustment value according to the speed difference, and providing the gain adjustment value to the duty generation step, and the duty generation step may change the duty according to the gain adjustment value output in the gain adjustment step and the duty update time adjustment.

Further, in an example, the duty generation step may include an addition step of adding the adjustment value according to the speed difference calculated in the speed difference detection step and a duty value generated in the previous duty generation step to output the added value; a selection output step of multi-receiving an output of the addition step and the duty value generated in the previous duty generation step to output any one according to the control in the feedback time adjustment step; and a duty output step of generating the duty by changing the duty when an output of the selection output step is a signal selected from the output of the addition step while receiving the output of the selection output step to generate the duty.

At this time, in accordance with another example, the feedback time adjustment step may control the previously generated duty value, which is received in the selection output step, to be selected and output in the selection output step when the duty variation is greater than a preset value.

Moreover, in another example, the feedback time adjustment step may control the previously generated duty value, which is received in the selection output step, to be continuously selected and output in the selection output step for a set time corresponding to the size of the duty variation.

Further, in an example, the method for controlling a motor speed may further include a duty-RPM conversion step of calculating the motor control speed from a PWM control signal before the speed difference detection step to provide the motor control speed to the speed difference detection step.

In accordance with another example, the method for controlling a motor speed may further include a PWM generation step of generating the PWM control signal for controlling the rotational speed of the motor from the duty value output in the duty generation step.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram schematically showing an apparatus for controlling a motor speed in accordance with one embodiment of the present invention;

FIG. 2 is a block diagram schematically showing an apparatus for controlling a motor speed in accordance with another embodiment of the present invention;

FIG. 3 is a block diagram schematically showing an apparatus for controlling a motor speed in accordance with another embodiment of the present invention;

FIG. 4 is a block diagram schematically showing an apparatus for controlling a motor speed in accordance with another embodiment of the present invention;

FIG. 5 is a flowchart schematically showing a method for controlling a motor speed in accordance with the other embodiment of the present invention; and

FIG. 6 is a flowchart schematically showing a method for controlling a motor speed in accordance with another embodiment of the present invention.

### DETAILED DESCRIPTION OF THE PREFERABLE EMBODIMENTS

Embodiments of the present invention to achieve the above-described objects will be described with reference to the accompanying drawings. In this description, the same elements are represented by the same reference numerals, and additional description which is repeated or limits interpretation of the meaning of the invention may be omitted.

In this specification, when an element is referred to as being “connected or coupled to” or “disposed in” another element, it can be “directly” connected or coupled to or “directly” disposed in the other element or connected or coupled to or disposed in the other element with another element interposed therebetween, unless it is referred to as being “directly coupled or connected to” or “directly disposed in” the other element.

Although the singular form is used in this specification, it should be noted that the singular form can be used as the concept representing the plural form unless being contradictory to the concept of the invention or clearly interpreted otherwise. It should be understood that the terms such as “having”, “including”, and “comprising” used herein do not preclude existence or addition of one or more other elements or combination thereof.

First, an apparatus for controlling a motor speed in accordance with a first embodiment of the present invention will be specifically described with reference to the drawings. At this time, the reference numeral that is not mentioned in the reference drawing may be the reference numeral that represents the same element in another drawing.

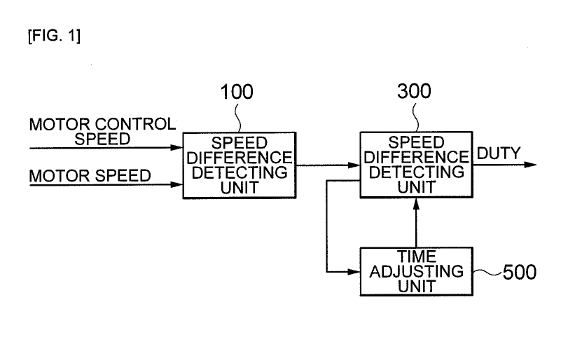

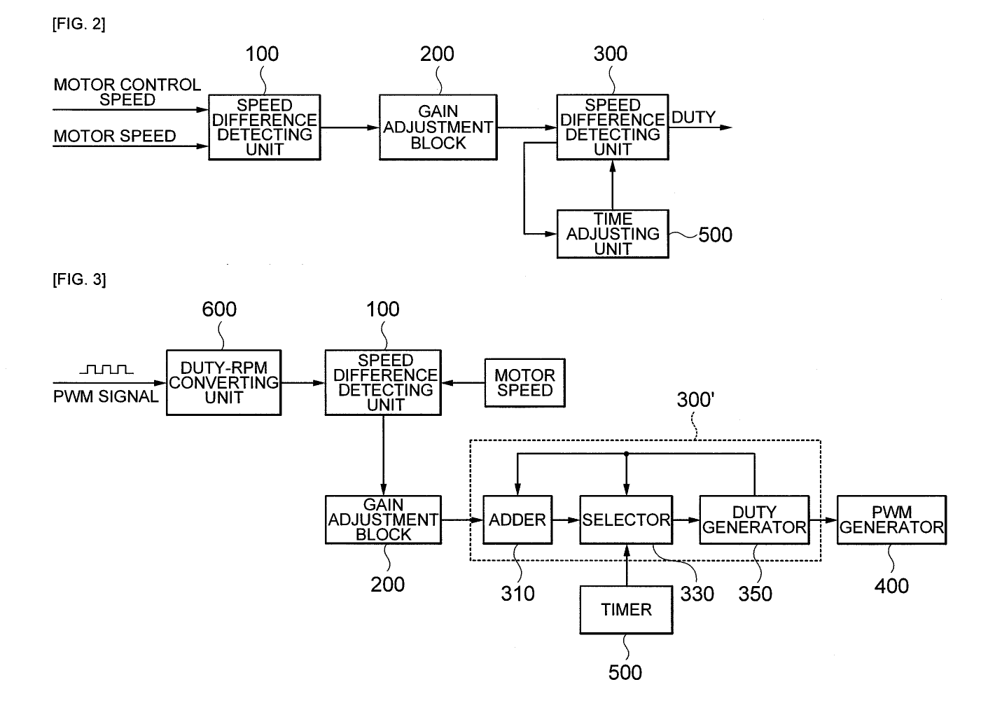

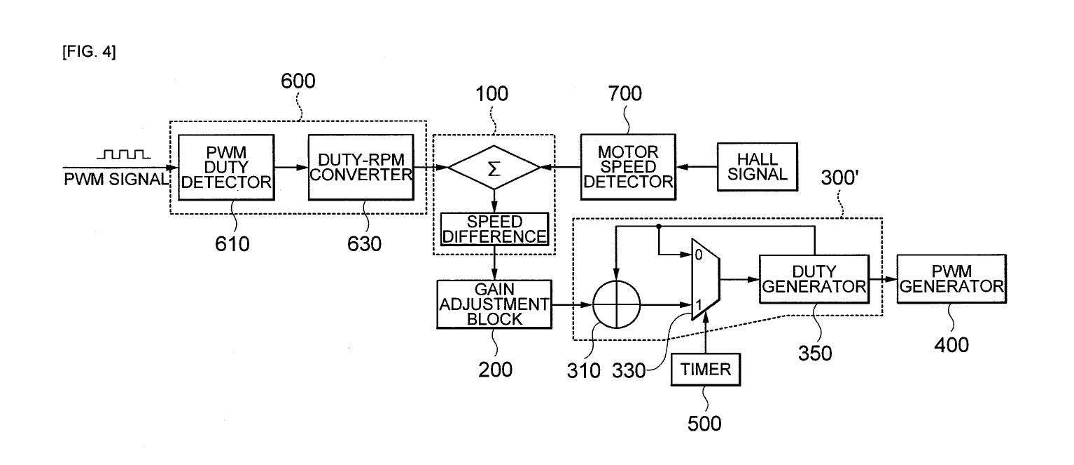

FIG. 1 is a block diagram schematically showing an apparatus for controlling a motor speed in accordance with one embodiment of the present invention, FIG. 2 is a block diagram schematically showing an apparatus for controlling a motor speed in accordance with another embodiment of the present invention, FIG. 3 is a block diagram schematically showing an apparatus for controlling a motor speed in accordance with another embodiment of the present invention, and FIG. 4 is a block diagram schematically showing an apparatus for controlling a motor speed in accordance with another embodiment of the present invention.

Referring to FIG. 1, an apparatus for controlling a motor speed in accordance with an example includes a speed difference detecting unit 100, a duty generating unit 300, and a time adjusting unit 500.

Specifically, the speed difference detecting unit 100 calculates a difference between a motor control speed and a detected motor speed. At this time, the motor control speed may be, for example, a motor control speed according to a PWM control signal.

Next, the duty generating unit 300 of FIG. 1 changes a duty according to the speed difference detected by the speed difference detecting unit 100 and duty update time adjustment.

The duty generating unit 300 will be more specifically described.

Referring to FIGS. 3 and/or 4, the duty generating unit 300 may include an adder 310, a selector 330, and a duty generator 350. At this time, the adder 310 adds an adjustment value according to the speed difference calculated by the speed difference detecting unit 100 and a duty value generated by the duty generator 350 in the previous step to output the added value. For example, the adder 310, as shown in FIGS. 3 and/or 4, may add a gain adjustment value output from a gain adjustment block 200 according to the speed difference calculated by the speed difference detecting unit 100 and the duty value generated by the duty generator 350 in the previous step.

Further, referring to FIGS. 3 and/or 4, the selector 330 multi-receives an output of the adder 310 and the duty value generated by the duty generator 350 in the previous step. At this time, the selector 330 may output an output signal according to any one of multiple inputs according to the control of the time adjusting unit 500.

At this time, when looking into the control of the time adjusting unit 500 on the selector 330, in an example, the time adjusting unit 500 may control the selector 330 to select and output the duty value generated in the previous step, which is received by the selector 330, when a duty variation is greater than a preset value.

Moreover, in another example, the time adjusting unit 500 may control the selector 330 to continuously select and output the duty value generated in the previous step, which is received by the selector 330, for a set time corresponding to the size of the duty variation.

Continuously, referring to FIGS. 3 and/or 4, the duty generator 350 may generate a duty by receiving an output of the selector 330. At this time, the duty generator 350 may output the duty by changing the duty when the output of the selector 330 is a signal selected from the output of the adder 310. If the output of the selector 330 is not the signal selected from the output of the adder 310 but the output selected from the duty value generated in the previous step, the duty generator 350 outputs the same duty as before.

Continuously, the time adjusting unit 500 of FIG. 1 adjusts a duty update time according to the duty variation in the duty generating unit 300. The time adjusting unit 500 may adjust a duty update time interval according to the duty variation using a timer.

When controlling the speed of a motor, in a conventional method of multiplying a difference between a reference speed (motor control speed) and a real motor speed by a gain, a variable with a sufficient width is needed for accurate control. Further, since a multiplier is needed, cost of implementation increases.

On the other hand, in accordance with an embodiment of the present invention, it is possible to stably change the speed of the motor by adjusting the duty update time. For example, it is possible to stably change the speed of the motor by adjusting the time when the duty is updated in addition to the gain adjustment having a constant or simple variable using an adder not a complex structure such as a multiplier. Since it is not easy for the adder and the simple variable to find an optimum value by themselves, it is possible to set an optimum value so that the speed of the motor can be stably changed by adjusting the update time.

In an embodiment of the present invention, it is possible to stably maintain the speed change of the motor by adjusting the duty update time interval to change the duty value once in a longer time if the duty value for controlling the speed of the motor is rapidly changed since the applied gain value is high, and reducing the duty update time when the speed of the motor is changed slower than a desired level.

In the present embodiment, it is possible to implement the gain adjustment block 200 having a simple structure, unlike a conventional gain adjustment block having a multiplier structure, by adjusting the update time when controlling the mechanical speed change of the motor.

In an example, when the duty variation is greater than a preset value, the time adjusting unit 500 may control the duty generating unit 300, for example, the selector 330 of FIGS. 3 and/or 4, to continuously select and output the received duty value generated in the previous step in order not to change the duty for a predetermined time. At this time, the time adjusting unit 500 may control the duty generating unit 300, for example, the selector 330 of FIGS. 3 and/or 4, to continuously select and output the received duty value generated in the previous step for a set time corresponding to the size of the duty variation. Accordingly, it is possible to stably change the speed of the motor by increasing the time interval when the duty is changed when the duty variation is greater than a predetermined value.

In FIGS. 3 and 4, although it is not shown that the duty variation is fed back to the time adjusting unit 500 from the output of the duty generating unit 300, the time adjusting unit 500 may adjust the duty update time interval according to the duty variation by receiving the duty variation from the output of the duty generating unit 300.

Another embodiment will be described with reference to FIG. 2. Referring to FIG. 2, the apparatus for controlling a motor speed may further include the gain adjustment block 200. The gain adjustment block 200 may be optional. At this time, the gain adjustment block 200 receives the speed difference calculated by the speed difference detecting unit 100 to output the gain adjustment value according to the speed difference to the duty generating unit 300.

When the gain adjustment value is output from the gain adjustment block 200, the duty generating unit 300 can change the duty according to the gain adjustment value and the duty update time adjustment.

Next, another example will be described with reference to FIG. 3.

Referring to FIG. 3, the apparatus for controlling a motor speed may further include a duty-RPM converting unit 600 which calculates the motor control speed from a PWM control signal to output the motor control speed to the speed difference detecting unit 100.

At this time, more specifically describing with reference to FIG. 4, in another example, the duty-RPM converting unit 600 may include a duty detector 610 and an RPM converter 630. The duty detector 610 detects the duty from the PWM control signal, and the RPM converter 630 converts the duty signal detected by the duty detector 610 into an RPM signal.

Further, describing another example with reference to FIG. 4, the apparatus for controlling a motor speed may further include a motor speed detector 700. At this time, the motor speed detector 700 detects the speed of the motor from a Hall sensor signal of the motor to output the detected signal to the speed difference detecting unit 100.

Next, describing another example with reference to FIGS. 3 and/or 4, the apparatus for controlling a motor speed may further include a PWM generator 400 which generates the PWM control signal for controlling the rotational speed of the motor from the duty value output from the duty generating unit 300.

Next, a method for controlling a motor speed in accordance with a second embodiment of the present invention will be specifically described with reference to the drawings. At this time, it is possible to refer to the apparatus for controlling a motor speed in accordance with the above-described first embodiment and FIGS. 1 to 4. Accordingly, repeated descriptions may be omitted.

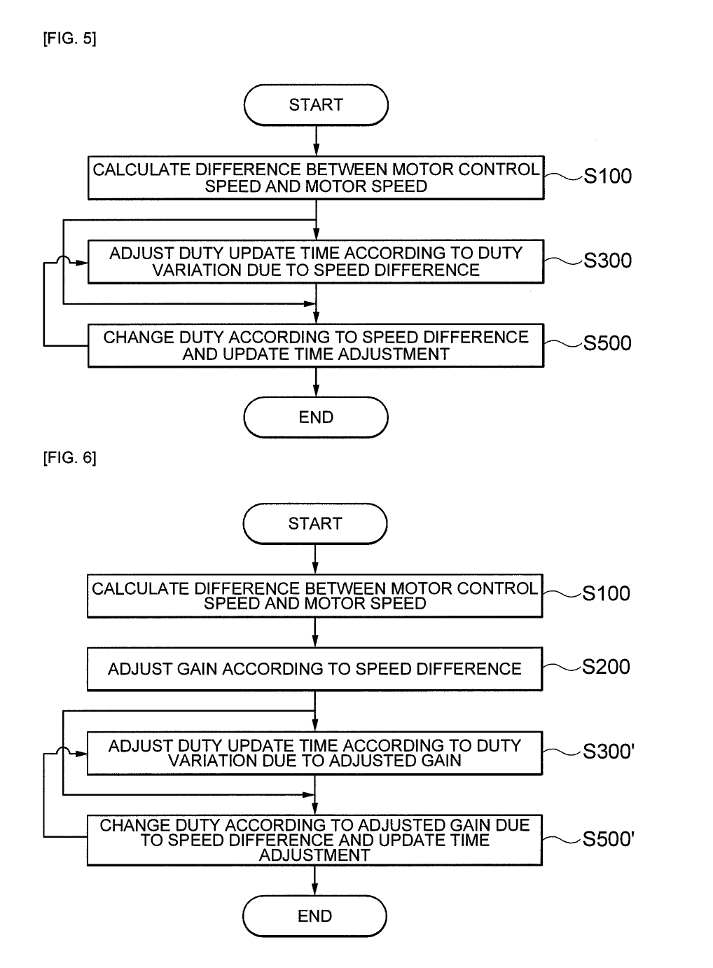

FIG. 5 is a flowchart schematically showing a method for controlling a motor speed in accordance with the other embodiment of the present invention, and FIG. 6 is a flowchart schematically showing a method for controlling a motor speed in accordance with another embodiment of the present invention.

Referring to FIG. 5, a method for controlling a motor speed in accordance with an example may include a speed difference detection step (S100), a duty generation step (S500), and a feedback time adjustment step (S300).

Specifically, referring to FIG. 5, the speed difference detection step (S100) calculates a difference between a motor control speed and a detected motor speed.

Next, referring to FIG. 5, the duty generation step (S500) generates a duty by changing the duty according to the speed difference detected in the speed difference detection step (S100) and duty update time adjustment.

The duty generation step (S500) of FIG. 5 will be further described with reference to FIGS. 3 and/or 4.

In an example, although not shown, the duty generation step (S500) of FIG. 5 may include an addition step, a selection output step, and a duty output step.

At this time, the addition step may add an adjustment value according to the speed difference calculated in the speed difference detection step (S100) of FIG. 5 and a duty value generated in the previous duty generation step (S500) to output the added value.

Further, although not shown, the selection output step, which corresponds to the selector 330 of FIGS. 3 and/or 4, multi-receives an output of the addition step and the duty value generated in the previous duty generation step (S500) and outputs any one according to the control in the feedback time adjustment step (S300).

At this time, the feedback time adjustment step (S300) may control the previously generated duty value, which is received in the selection output step, to be selected and output in the selection output step when a duty variation is greater than a preset value. Moreover, the feedback time adjustment step (S300) may control the previously generated duty value, which is received in the selection output step, to be continuously selected and output in the selection output step for a set time corresponding to the size of the duty variation.

And, although not shown, the duty output step, which corresponds to the duty generator 350 of FIGS. 3 and/or 4, generates the duty by receiving an output of the selection output step. At this time, the duty output step may generate the duty by changing the duty when the output of the selection output step is a signal selected from the output of the addition step.

Continuously, referring to FIG. 5, the feedback time adjustment step (S300) feeds back the duty variation generated in the duty generation step (S500) to adjust a duty update time for the control in the duty generation step (S500).

In accordance with an embodiment of the present invention, it is possible to stably change the speed of the motor by adjusting the duty update time. It is possible to stably maintain the speed change of the motor by adjusting the duty update time interval to change the duty value once in a longer time if the duty value for controlling the speed of the motor is rapidly changed since the applied gain value is high, and reducing the duty update time when the speed of the motor is changed slower than a desired level.

In accordance with an example, when the duty variation is greater than a preset value, the feedback time adjustment step (S300) may control the received previously generated duty value to be selected and output in the duty generation step (S500), for example, in the selection output step although not shown.

Moreover, in another example, the feedback time adjustment step (S300) may control the received previously generated duty value to be continuously selected and output in the duty generation step (S500), for example, in the selection output step although not shown, for a set time corresponding to the size of the duty variation.

Another example of the method for controlling a motor speed in accordance with the second embodiment of the present invention will be described with reference to FIG. 6.

Referring to FIG. 6, the method for controlling a motor speed in accordance with an example may further include a gain adjustment step (S200). At this time, the gain adjustment step (S200) receives the speed difference calculated in the speed difference detection step (S100), outputs a gain adjustment value according to the speed difference, and provides the gain adjustment value to the duty generation step (S500′).

Accordingly, the duty generation step (S500′) can change the duty according to the gain adjustment value output in the gain adjustment step (S200) and the duty update time adjustment.

Further, although not shown, a description will be made with reference to FIGS. 3 and/or 4. At this time, in an example, the method for controlling a motor speed may further include a duty-RPM conversion step (not shown) which calculates the motor control speed from a PWM control signal before the speed difference detection step (S100) of FIGS. 5 and/or 6 to provide the motor control speed to the speed difference detection step (S100).

Although not shown, another example will be described with reference to FIGS. 3 and/or 4. At this time, the method for controlling a motor speed may further include a PWM generation step (not shown) which generates the PWM control signal for controlling the rotational speed of the motor from the duty value output in the duty generation step (S500,S500′) of FIGS. 5 and/or 6.

According to the embodiments of the present invention, it is possible to stably change the speed of a motor by adjusting a duty update time interval according to a speed variation of the motor.

It is apparent that various effects which have not been directly mentioned according to the various embodiments of the present invention can be derived by those skilled in the art from various constructions according to the embodiments of the present invention.

The above-described embodiments and the accompanying drawings are provided as examples to help understanding of those skilled in the art, not limiting the scope of the present invention. Further, embodiments according to various combinations of the above-described components will be apparently implemented from the foregoing specific descriptions by those skilled in the art. Therefore, the various embodiments of the present invention may be embodied in different forms in a range without departing from the essential concept of the present invention, and the scope of the present invention should be interpreted from the invention defined in the claims. It is to be understood that the present invention includes various modifications, substitutions, and equivalents by those skilled in the art.

What is claimed is:

1. An apparatus for controlling a motor speed, comprising:
a speed difference detecting unit for calculating a difference between a motor control speed and a detected motor speed;
a duty generating unit for changing a duty according to the speed difference detected by the speed difference detecting unit and duty update time adjustment; and
a time adjusting unit for adjusting a duty update time according to a duty variation in the duty generating unit.

2. The apparatus for controlling a motor speed according to claim 1, the apparatus further comprises a gain adjustment block which receives the speed difference calculated by the speed difference detecting unit to output a gain adjustment value according to the speed difference to the duty generating unit, wherein
the duty generating unit changes the duty according to the gain adjustment value output from the gain adjustment block and the duty update time adjustment.

3. The apparatus for controlling a motor speed according to claim 1, wherein the duty generating unit comprises:
an adder which adds the adjustment value according to the speed difference calculated by the speed difference detecting unit and a duty value generated by a duty generator in the previous step to output the added value;
a selector which multi-receives an output of the adder and the duty value generated by the duty generator in the previous step to output any one according to the control of the time adjusting unit; and
the duty generator which generates the duty by changing the duty when an output of the selector is a signal selected from the output of the adder while receiving the output of the selector to generate the duty.

4. The apparatus for controlling a motor speed according to claim 3, wherein the time adjusting unit controls the selector to select and output the duty value generated in the previous step, which is received by the selector, when the duty variation is greater than a preset value.

5. The apparatus for controlling a motor speed according to claim 4, wherein the time adjusting unit controls the selector to continuously select and output the duty value generated in the previous step, which is received by the selector, for a set time corresponding to the size of the duty variation.

6. The apparatus for controlling a motor speed according to claim 1, further comprising:
a duty-RPM converting unit which calculates the motor control speed from a PWM control signal to output the motor control speed to the speed difference detecting unit.

7. The apparatus for controlling a motor speed according to claim 6, wherein the duty-RPM converting unit comprises:
a duty detector for detecting a duty from the PWM control signal; and
an RPM converter for converting the duty signal detected by the duty detector into an RPM signal.

8. The apparatus for controlling a motor speed according to claim 1, further comprising:
a motor speed detector which detects the motor speed from a Hall sensor signal of the motor to output the motor speed to the speed difference detecting unit.

9. The apparatus for controlling a motor speed according to claim 1, further comprising:
a PWM generator for generating the PWM control signal for controlling the rotational speed of the motor from the duty value output from the duty generating unit.

10. A method for controlling a motor speed, comprising:
a speed difference detection step of calculating a difference between a motor control speed and a detected motor speed;
a duty generation step of generating a duty by changing the duty according to the speed difference detected in the speed difference detection step and duty update time adjustment; and
a feedback time adjustment step of feeding back a duty variation generated in the duty generation step to adjust a duty update time for control in the duty generation step.

11. The method for controlling a motor speed according to claim 10, the method further comprises a gain adjustment step of receiving the speed difference calculated in the speed difference detection step, outputting a gain adjustment value according to the speed difference, and providing the gain adjustment value to the duty generation step, wherein
the duty generation step changes the duty according to the gain adjustment value output in the gain adjustment step and the duty update time adjustment.

12. The method for controlling a motor speed according to claim 10, wherein the duty generation step comprises:
an addition step of adding the adjustment value according to the speed difference calculated in the speed difference detection step and a duty value generated in the previous duty generation step to output the added value;
a selection output step of multi-receiving an output of the addition step and the duty value generated in the previous duty generation step to output any one according to the control in the feedback time adjustment step; and
a duty output step of generating the duty by changing the duty when an output of the selection output step is a signal selected from the output of the addition step while receiving the output of the selection output step to generate the duty.

13. The method for controlling a motor speed according to claim 12, wherein the feedback time adjustment step controls the previously generated duty value, which is received in the selection output step, to be selected and output in the selection output step when the duty variation is greater than a preset value.

14. The method for controlling a motor speed according to claim 13, wherein the feedback time adjustment step controls the previously generated duty value, which is received in the selection output step, to be continuously selected and output in the selection output step for a set time corresponding to the size of the duty variation.

15. The method for controlling a motor speed according to claim 10, further comprising:
a duty-RPM conversion step of calculating the motor control speed from a PWM control signal before the speed difference detection step to provide the motor control speed to the speed difference detection step.

16. The method for controlling a motor speed according to claim 10, further comprising:
a PWM generation step of generating the PWM control signal for controlling the rotational speed of the motor from the duty value output in the duty generation step.

17. The method for controlling a motor speed according to claim 11, further comprising:
a PWM generation step of generating the PWM control signal for controlling the rotational speed of the motor from the duty value output in the duty generation step.

18. The method for controlling a motor speed according to claim 12, further comprising:
a PWM generation step of generating the PWM control signal for controlling the rotational speed of the motor from the duty value output in the duty generation step.

19. The method for controlling a motor speed according to claim 13, further comprising:
a PWM generation step of generating the PWM control signal for controlling the rotational speed of the motor from the duty value output in the duty generation step.

20. The method for controlling a motor speed according to claim 14, further comprising:
a PWM generation step of generating the PWM control signal for controlling the rotational speed of the motor from the duty value output in the duty generation step.
